(19) United States
(12) Patent Application Publication
(10) Pub. No.: US 2013/0104562 A1
(43) Pub. Date: May 2, 2013

(54) Low Emission Tripe-Cycle Power Generation Systems and Methods

(71) Applicants: Russell H. Oelfke, Houston, TX (US); Moses Minta, Missouri City, TX (US)

(72) Inventors: Russell H. Oelfke, Houston, TX (US); Moses Minta, Missouri City, TX (US)

(21) Appl. No.: 13/702,536

(22) PCT Filed: Jun. 9, 2011
(86) PCT No.: PCT/US11/39824

§ 371 Date: Dec. 6, 2012

Related U.S. Application Data
(60) Provisional application No. 61/361,170, filed on Jul. 2, 2010.

(51) Int. Cl. F02C 3/02

(52) U.S. Cl. CPC F02C 3/02
USPC 60/773; 60/728

(57) ABSTRACT

Methods and systems for low emission power generation in hydrocarbon recovery processes are provided. One system includes a gas turbine system adapted to combust a fuel and an oxidant in the presence of a compressed recycle stream to provide mechanical power and a gaseous exhaust. The compressed recycle stream acts to moderate the temperature of the combustion process. A boost compressor can boost the pressure of the gaseous exhaust before being compressed into the compressed recycle stream. A purge stream may be tapped off from the compressed recycle stream and directed to a C02 separator which discharges C02 and a nitrogen-rich gas, which may be expanded in a gas expander to generate additional mechanical power.

### CROSS-REFERENCE TO RELATED APPLICATIONS

This application claims the benefit of U.S. Provisional Patent Application 61/361,170, filed Jul. 2, 2010, entitled “Low Emission Triple-Cycle Power Generation Systems and Methods,” the entirety of which is incorporated by reference herein.

This application contains subject matter related to U.S. Patent Application No. 61/361,169, filed Jul. 2, 2010 entitled “Systems and Methods for Controlling Combustion of a Fuel”; U.S. Patent Application No. 61/361,173, filed Jul. 2, 2010, entitled “Low Emission Triple-Cycle Power Generation Systems and Methods”; U.S. Patent Application No. 61/361,176, filed Jul. 2, 2010, entitled “Stoichiometric Combustion With Exhaust Gas Recirculation and Direct Contact Cooler”; U.S. Patent Application No. 61/361,178, filed Jul. 2, 2010, entitled “Stoichiometric Combustion of Enriched Air With Exhaust Gas Recirculation” and U.S. Patent Application No. 61/361,180 filed Jul. 2, 2010, entitled “Low Emission Power Generation Systems and Methods”.

### FIELD OF THE DISCLOSURE

Embodiments of the disclosure relate to low emission power generation in combined-cycle power systems. More particularly, embodiments of the disclosure relate to methods and apparatuses for combusting a fuel for enhanced CO₂ manufacture and capture.

### BACKGROUND OF THE DISCLOSURE

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Many oil producing countries are experiencing strong domestic growth in power demand and have an interest in enhanced oil recovery (EOR) to improve oil recovery from their reservoirs. Two common EOR techniques include nitrogen (N₂) injection for reservoir pressure maintenance and carbon dioxide (CO₂) injection for miscible flooding for EOR. There is also a global concern regarding green house gas (GHG) emissions. This concern combined with the implementation of cap-and-trade policies in many countries make reducing CO₂ emissions a priority for these and other countries as well as the companies that operate hydrocarbon production systems therein.

Some approaches to lower CO₂ emissions include fuel de-carbonization or post-combustion capture using solvents, such as amines. However, both of these solutions are expensive and reduce power generation efficiency, resulting in lower power production, increased fuel demand and increased cost of electricity to meet domestic power demand. In particular, the presence of oxygen, SO_{X}, and NO_{X} components makes the use of amine solvent absorption very problematic. Another approach is an oxyfuel gas turbine in a combined cycle (e.g. where exhaust heat from the gas turbine Brayton cycle is captured to make steam and produce additional power in a Rankin cycle). However, there are no commercially available gas turbines that can operate in such a cycle and the power required to produce high purity oxygen significantly reduces the overall efficiency of the process. Several studies have compared these processes and show some of the advantages of each approach. See, e.g. BOLLAND, OLAV, and UNDRUM, HENRIETTE, Removal of CO₂ from Gas Turbine Power Plants: Evaluation of pre-and post-combustion methods, SINTEF Group, found at http://www.energy.sintef.no/publ/xergi/98/3/3art-8-engelsk.htm (1998).

Other approaches to lower CO₂ emissions include stoichiometric exhaust gas recirculation, such as in natural gas combined cycles (NGCC). In a conventional NGCC system, only about 40% of the air intake volume is required to provide adequate stoichiometric combustion of the fuel, while the remaining 60% of the air volume serves to moderate the temperature and cool the exhaust gas so as to be suitable for introduction into the succeeding expander, but also disadvantageously generate an excess oxygen byproduct which is difficult to remove. The typical NGCC produces low pressure exhaust gas which requires a fraction of the power produced to extract the CO₂ for sequestration or EOR, thereby reducing the thermal efficiency of the NGCC. Further, the equipment for the CO₂ extraction is large and expensive, and several stages of compression are required to take the ambient pressure gas to the pressure required for EOR or sequestration. Such limitations are typical of post-combustion carbon capture from low pressure exhaust gas associated with the combustion of other fossil fuels, such as coal.

The foregoing discussion of need in the art is intended to be representative rather than exhaustive. A technology addressing one or more such needs, or some other related shortcoming in the field, would benefit power generation in combined-cycle power systems.

### SUMMARY OF THE DISCLOSURE

The present disclosure provides systems and methods for combusting fuel, producing power, processing produced hydrocarbons, and/or generating inert gases. The systems may be implemented in a variety of circumstances and the products of the system may find a variety of uses. For example, the systems and methods may be adapted to produce a carbon dioxide stream and a nitrogen stream, each of which may have a variety of possible uses in hydrocarbon production operations. Similarly, the inlet fuel may come from a variety of sources. For example, the fuel may be any conventional fuel stream or may be a produced hydrocarbon stream, such as one containing methane and heavier hydrocarbons.

One exemplary system within the scope of the present disclosure includes both a gas turbine system and an exhaust gas recirculation system. The gas turbine system may include a first compressor configured to receive and compress a cooled recycle gas stream into a compressed recycle stream. The gas turbine system may further include a second compressor configured to receive and compress a feed oxidant into a compressed oxidant. Still further, the gas turbine system may include a combustion chamber configured to receive the compressed recycle stream and the compressed oxidant and to combust a fuel stream, wherein the compressed recycle stream serves as a diluent to moderate combustion temperatures. The gas turbine system further includes an expander coupled to the first compressor and configured to receive a discharge from the combustion chamber to generate a gaseous exhaust stream and at least partially drive the first compressor. The gas turbine may be further adapted to produce auxiliary power for use in other systems. The exemplary system further includes an exhaust gas recirculation system comprising a heat recovery steam generator and a boost compressor. The heat recovery steam generator may be configured to receive the gaseous exhaust stream from the expander and to generate steam and a cooled exhaust stream. The cooled exhaust stream may be recycled to the gas turbine system becoming a cooled recycle gas stream. In route to the gas turbine system, the cooled recycle gas stream may pass through a boost compressor configured to receive and increase the pressure of the cooled recycle gas stream before injection into the first compressor.

### BRIEF DESCRIPTION OF THE DRAWINGS

The foregoing and other advantages of the present disclosure may become apparent upon reviewing the following detailed description and drawings of non-limiting examples of embodiments in which:

FIG. 1 depicts an integrated system for low emission power generation and enhanced CO₂ recovery, according to one or more embodiments of the present disclosure.

FIG. 2 depicts another integrated system for low emission power generation and enhanced CO₂ recovery, according to one or more embodiments of the present disclosure.

FIG. 3 depicts another integrated system for low emission power generation and enhanced CO₂ recovery, according to one or more embodiments of the present disclosure.

### DETAILED DESCRIPTION OF THE DISCLOSURE

In the following detailed description section, the specific embodiments of the present disclosure are described in connection with preferred embodiments. However, to the extent that the following description is specific to a particular embodiment or a particular use of the present disclosure, this is intended to be for exemplary purposes only and simply provides a description of the exemplary embodiments. Accordingly, the disclosure is not limited to the specific embodiments described below, but rather, it includes all alternatives, modifications, and equivalents falling within the true spirit and scope of the appended claims.

Various terms as used herein are defined below. To the extent a term used in a claim is not defined below, it should be given the broadest definition persons in the pertinent art have given that term as reflected in at least one printed publication or issued patent.

As used herein, the term “natural gas” refers to a multi-component gas obtained from a crude oil well (associated gas) or from a subterranean gas-bearing formation (non-associated gas). The composition and pressure of natural gas can vary significantly. A typical natural gas stream contains methane (CH₄) as a major component, i.e. greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., hydrogen sulfide, carbon dioxide), or any combination thereof. The natural gas can also contain minor amounts of contaminants such as water, nitrogen, iron sulfide, wax, crude oil, or any combination thereof.

As used herein, the term “stoichiometric combustion” refers to a combustion reaction having a volume of reactants comprising a fuel and an oxidizer and a volume of products formed by combusting the reactants where the entire volume of the reactants is used to form the products. As used herein, the term “substantially stoichiometric combustion” refers to a combustion reaction having a molar ratio of combustion fuel to oxygen ranging from about plus or minus 10% of the oxygen required for a stoichiometric ratio or more preferably from about plus or minus 5% of the oxygen required for the stoichiometric ratio. For example, the stoichiometric ratio of fuel to oxygen for methane is 1:2 (CH₄+2O₂>CO₂+2H₂O). Propane will have a stoichiometric ratio of fuel to oxygen of 1:5. Another way of measuring substantially stoichiometric combustion is as a ratio of oxygen supplied to oxygen required for stoichiometric combustion, such as from about 0.9:1 to about 1.1:1, or more preferably from about 0.95:1 to about 1.05:1.

As used herein, the term “stream” refers to a volume of fluids, although use of the term stream typically means a moving volume of fluids (e.g., having a velocity or mass flow rate). The term “stream,” however, does not require a velocity, mass flow rate, or a particular type of conduit for enclosing the stream.

Embodiments of the presently disclosed systems and processes may be used to produce ultra low emission electric power and CO₂ for enhanced oil recovery (EOR) or sequestration applications. According to embodiments disclosed herein, a mixture of air and fuel can be stoichiometrically or substantially stoichiometrically combusted and mixed with a stream of recycled exhaust gas. In some implementations, the combustor may be operated in an effort to obtain stoichiometric combustion, with some deviation to either side of stoichiometric combustion. Additionally or alternatively, the combustor and the gas turbine system may be adapted with a preference to substoichiometric combustion to err or deviate on the side of depriving the system of oxygen rather than supplying excess oxygen. The stream of recycled exhaust gas, generally including products of combustion such as CO₂, can be used as a diluent to control or otherwise moderate the temperature of the combustion chamber and/or the temperature of the exhaust gas entering the succeeding expander.

Combustion at near stoichiometric conditions (or “slightly rich” combustion) can prove advantageous in order to eliminate the cost of excess oxygen removal. By cooling the exhaust gas and condensing the water out of the stream, a relatively high content CO₂ stream can be produced. While a portion of the recycled exhaust gas can be utilized for temperature moderation in the closed Brayton cycle, a remaining purge stream can be used for EOR applications and electric power can be produced with little or no SO_{X}, NO_{X}, or CO₂ being emitted to the atmosphere.

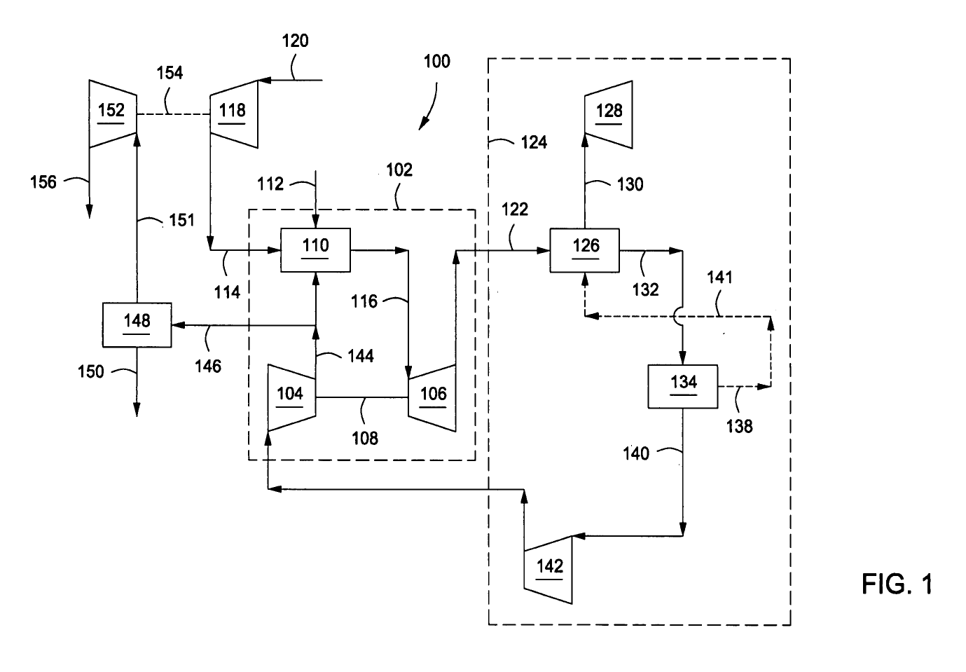

Referring now to the figures, FIG. 1 depicts a schematic of an illustrative integrated system 100 for power generation and CO₂ recovery using a combined-cycle arrangement, according to one or more embodiments. In at least one embodiment, the power generation system 100 can include a gas turbine system 102 characterized as a power-producing, closed Brayton cycle. The gas turbine system 102 can have a first or main compressor 104 coupled to an expander 106 via a shaft 108. The shaft 108 can be any mechanical, electrical, or other power coupling, thereby allowing a portion of the mechanical energy generated by the expander 106 to drive the main compressor 104. In at least one embodiment, the gas turbine system 102 can be a standard gas turbine, where the main compressor 104 and expander 106 form the compressor and expander ends, respectively. In other embodiments, however, the main compressor 104 and expander 106 can be individualized components in the system 102.

The gas turbine system 102 can also include a combustion chamber 110 configured to combust a fuel in line 112 mixed with a compressed oxidant in line 114. In one or more embodiments, the fuel in line 112 can include any suitable hydrocarbon gas or liquid, such as natural gas, methane, ethane, naphtha, butane, propane, syngas, diesel, kerosene, aviation fuel, coal derived fuel, bio-fuel, oxygenated hydrocarbon feedstock, or combinations thereof. The compressed oxidant in line 114 can be derived from a second or inlet compressor 118 fluidly coupled to the combustion chamber 110 and adapted to compress a feed oxidant 120. In one or more embodiments, the feed oxidant 120 can include any suitable gas containing oxygen, such as air, oxygen-rich air, oxygen-depleted air, pure oxygen, or combinations thereof.

As will be described in more detail below, the combustion chamber 110 can also receive a compressed recycle stream 144, including an exhaust gas primarily having CO₂ and nitrogen components. The compressed recycle stream 144 can be derived from the main compressor 104 and adapted to help facilitate the stoichiometric or substantially stoichiometric combustion of the compressed oxidant in line 114 and fuel in line 112, and also increase the CO₂ concentration in the exhaust gas. A discharge stream 116 directed to the inlet of the expander 106 can be generated as a product of combustion of the fuel in line 112 and the compressed oxidant in line 114, in the presence of the compressed recycle stream 144. In at least one embodiment, the fuel in line 112 can be primarily natural gas, thereby generating a discharge 116 including volumetric portions of vaporized water, CO₂, nitrogen, nitrogen oxides (NOx), and sulfur oxides (SO_{X}). In some embodiments, a small portion of unburned fuel or other compounds may also be present in the discharge 116 due to combustion equilibrium limitations. As the discharge stream 116 expands through the expander 106 it generates mechanical power to drive the main compressor 104, an electrical generator, or other facilities, and also produce a gaseous exhaust stream 122 having a heightened CO₂ content resulting from the influx of the compressed recycle exhaust gas in line 144. The mechanical power generated by the expander 106 may additionally or alternatively be used for other purposes, such as to provide electricity to a local grid or to drive other systems in a facility or operation.

The power generation system 100 can also include an exhaust gas recirculation (EGR) system 124. In one or more embodiments, the EGR system 124 can include a heat recovery steam generator (HRSG) 126, or similar device, fluidly coupled to a steam gas turbine 128. In at least one embodiment, the combination of the HRSG 126 and the steam gas turbine 128 can be characterized as a closed Rankine cycle. In combination with the gas turbine system 102, the HRSG 126 and the steam gas turbine 128 can form part of a combined-cycle power generating plant, such as a natural gas combined-cycle (NGCC) plant. The gaseous exhaust stream 122 can be sent to the HRSG 126 in order to generate a stream of steam in line 130 and a cooled exhaust gas in line 132. In one embodiment, the steam in line 130 can be sent to the steam gas turbine 128 to generate additional electrical power.

The cooled exhaust gas in line 132 can be sent to at least one cooling unit 134 configured to reduce the temperature of the cooled exhaust gas in line 132 and generate a cooled recycle gas stream 140. In one or more embodiments, the cooling unit 134 can be a direct contact cooler, trim cooler, a mechanical refrigeration unit, or combinations thereof. The cooling unit 134 can also be configured to remove a portion of condensed water via a water dropout stream 138 which can, in at least one embodiment, be routed to the HRSG 126 via line 141 to provide a water source for the generation of additional steam in line 130. In one or more embodiments, the cooled recycle gas stream 140 can be directed to a boost compressor 142 fluidly coupled to the cooling unit 134. Cooling the cooled exhaust gas in line 132 in the cooling unit 134 can reduce the power required to compress the cooled recycle gas stream 140 in the boost compressor 142.

The boost compressor 142 can be configured to increase the pressure of the cooled recycle gas stream 140 before it is introduced into the main compressor 104. As opposed to a conventional fan or blower system, the boost compressor 142 increases the overall density of the cooled recycle gas stream 140, thereby directing an increased mass flow rate for the same volumetric flow to the main compressor 104. Because the main compressor 104 is typically volume-flow limited, directing more mass flow through the main compressor 104 can result in a higher discharge pressure from the main compressor 104, thereby translating into a higher pressure ratio across the expander 106. A higher pressure ratio generated across the expander 106 can allow for higher inlet temperatures and, therefore, an increase in expander 106 power and efficiency. This can prove advantageous since the CO₂-rich discharge 116 generally maintains a higher specific heat capacity.

The main compressor 104 can be configured to compress the cooled recycle gag stream 140 received from the boost compressor 142 to a pressure nominally above the combustion chamber 110 pressure, thereby generating the compressed recycle stream 144. In at least one embodiment, a purge stream 146 can be tapped from the compressed recycle stream 144 and subsequently treated in a CO₂ separator 148 to capture CO₂ at an elevated pressure via line 150. The separated CO₂ in line 150 can be used for sales, used in another process requiring carbon dioxide, and/or compressed and injected into a terrestrial reservoir for enhanced oil recovery (EOR), sequestration, or another purpose.

A residual stream 151, essentially depleted of CO₂ and consisting primarily of nitrogen, can be derived from the CO₂ separator 148. In some implementations, the nitrogen-rich residual stream 151 may be vented and/or used directly in one or more operations. In one or more embodiments, the residual stream 151, which may be at pressure, can be expanded in a gas expander 152, such as a power-producing nitrogen expander, fluidly coupled to the CO₂ separator 148. As depicted in FIGS. 1-3, the gas expander 152 can be optionally coupled to the inlet compressor 118 through a common shaft 154 or other mechanical, electrical, or other power coupling, thereby allowing a portion of the power generated by the gas expander 152 to drive the inlet compressor 118. After expansion in the gas expander 152, an exhaust gas in line 156, consisting primarily of nitrogen, can be vented to the atmosphere or implemented into other applications known in the art. For example, the expanded nitrogen stream can be used in an evaporative cooling process configured to further reduce the temperature of the exhaust gas as generally described in the concurrently filed U.S. patent application entitled “Stoichiometric Combustion with Exhaust Gas Recirculation and Direct Contact Cooler,” the contents of which are hereby incorporated by reference to the extent not inconsistent with the present disclosure. In at least one embodiment, the combination of the gas expander 152, inlet compressor 118, and CO₂ separator can be characterized as an open Brayton cycle, or the third power producing component of the system 100.

In other embodiments, however, the gas expander 152 can be used to provide power to other applications, and not directly coupled to the stoichiometric compressor 118. For example, there may be a substantial mismatch between the power generated by the expander 152 and the requirements of the compressor 118. In such cases, the expander 152 could be adapted to drive a smaller compressor (not shown) that demands less power. In yet other embodiments, the gas expander 152 can be replaced with a downstream compressor (not shown) configured to compress the residual stream 151 and generate a compressed exhaust gas suitable for injection into a reservoir for pressure maintenance or EOR applications.

The EGR system 124 as described herein, especially with the addition of the boost compressor 142, can be implemented to achieve a higher concentration of CO₂ in the exhaust gas of the power generation system 100, thereby allowing for more effective CO₂ separation for subsequent sequestration, pressure maintenance, or EOR applications. For instance, embodiments disclosed herein can effectively increase the concentration of CO₂ in the exhaust gas stream to about 10 vol % or higher. To accomplish this, the combustion chamber 110 can be adapted to stoichiometrically combust the incoming mixture of fuel in line 112 and compressed oxidant in line 114. In order to moderate the temperature of the stoichiometric combustion to meet expander 106 inlet temperature and component cooling requirements, a portion of the exhaust gas derived from the compressed recycle stream 144 can be simultaneously injected into the combustion chamber 110 as a diluent. Thus, embodiments of the disclosure can essentially eliminate any excess oxygen from the exhaust gas while simultaneously increasing its CO₂ composition. As such, the gaseous exhaust stream 122 can have less than about 3.0 vol % oxygen, or less than about 1.0 vol % oxygen, or less than about 0.1 vol % oxygen, or even less than about 0.001 vol % oxygen.

The specifics of exemplary operation of the system 100 will now be discussed. As can be appreciated, specific temperatures and pressures achieved or experienced in the various components of any of the embodiments disclosed herein can change depending on, among other factors, the purity of the oxidant used and the specific makes and/or models of expanders, compressors, coolers, etc. Accordingly, it will be appreciated that the particular data described herein is for illustrative purposes only and should not be construed as the only interpretation thereof. In an embodiment, the inlet compressor 118 can be configured to provide compressed oxidant in line 114 at pressures ranging between about 280 psia and about 300 psia. Also contemplated herein, however, is aeroderivative gas turbine technology, which can produce and consume pressures of up to about 750 psia and more.

The main compressor 104 can be configured to compress recycled exhaust gas into the compressed recycle stream 144 at a pressure nominally above or at the combustion chamber 110 pressure, and use a portion of that recycled exhaust gas as a diluent in the combustion chamber 110. Because amounts of diluent needed in the combustion chamber 110 can depend on the purity of the oxidant used for stoichiometric combustion or the model of expander 106, a ring of thermocouples and/or oxygen sensors (not shown) can be associated with the combustion chamber or the gas turbine system generally to determine, by direct measurement or by estimation and/or calculation, the temperature and/or oxygen concentration in one or more streams. For example, thermocouples and/or oxygen sensors may be disposed on the outlet of the combustion chamber 110, the inlet of the expander 106, and/or the outlet of the expander 106. In operation, the thermocouples and sensors can be adapted to regulate and determine the volume of exhaust gas required as diluent to cool the products of combustion to the required expander inlet temperature, and also regulate the amount of oxidant being injected into the combustion chamber 110. Thus, in response to the heat requirements detected by the thermocouples and the oxygen levels detected by the oxygen sensors, the volumetric mass flow of compressed recycle stream 144 and compressed oxidant in line 114 can be manipulated or controlled to match the demand.

In at least one embodiment, a pressure drop of about 12-13 psia can be experienced across the combustion chamber 110 during stoichiometric combustion. Combustion of the fuel in line 112 and the compressed oxidant in line 114 can generate temperatures between about 2000° F. and about 3000° F. and pressures ranging from 250 psia to about 300 psia. Because of the increased mass flow and higher specific heat capacity of the CO₂-rich exhaust gas derived from the compressed recycle stream 144, a higher pressure ratio can be achieved across the expander 106, thereby allowing for higher inlet temperatures and increased expander 106 power.

The gaseous exhaust stream 122 exiting the expander 106 can have a pressure at or near ambient. In at least one embodiment, the gaseous exhaust stream 122 can have a pressure of about 15.2 psia. The temperature of the gaseous exhaust stream 122 can range from about 1180° F. to about 1250° F. before passing through the HRSG 126 to generate steam in line 130 and a cooled exhaust gas in line 132. The cooled exhaust gas in line 132 can have a temperature ranging from about 190° F. to about 200° F. In one or more embodiments, the cooling unit 134 can reduce the temperature of the cooled exhaust gas in line 132 thereby generating the cooled recycle gas stream 140 having a temperature between about 32° F. and 120° F., depending primarily on wet bulb temperatures in specific locations and during specific seasons. Depending on the degree of cooling provided by the cooling unit 134, the cooling unit may be adapted to increase the mass flow rate of the cooled recycled gas stream.

According to one or more embodiments, the boost compressor 142 can be configured to elevate the pressure of the cooled recycle gas stream 140 to a pressure ranging from about 17.1 psia to about 21 psia. As a result, the main compressor 104 receives and compresses a recycled exhaust gas with a higher density and increased mass flow, thereby allowing for a substantially higher discharge pressure while maintaining the same or similar pressure ratio. In at least one embodiment, the temperature of the compressed recycle stream 144 discharged from the main compressor 104 can be about 800° F., with a pressure of around 280 psia.

The following table provides testing results and performance estimations based on combined-cycle gas turbines, with and without the added benefit of a boost compressor 142, as described herein.

TABLE 1
Triple-Cycle Performance Comparison

| | Recirc. Cycle | Recirc. Cycle w/ |
|---|---|---|
| | w/o Boost | Boost |
| Power (MW) | Compressor | Compressor |
| Gas Turbine Expander Power | 1055 | 1150 |
| Main Compressor | 538 | 542 |
| Fan or Boost Compressor | 13 | 27 |
| Inlet Compressor | 283 | 315 |
| Total Compression Power | 835 | 883 |
| Net Gas Turbine Power | 216 | 261 |
| Steam Turbine Net Power | 395 | 407 |
| Standard Machinery Net Power | 611 | 668 |
| Aux. Losses | 13 | 15 |
| Nitrogen Expander Power | 156 | 181 |
| Combined Cycle Power | 598 | 653 |
| Efficiency | | |
| Fuel Rate (mBTU/hr) | 5947 | 6322 |
| Heat Rate (BTU/kWh) | 9949 | 9680 |
| Combined Cycle Eff. (% lhv) | 34.3 | 35.2 |
| CO₂ Purge Pressure (psia) | 280 | 308 |

As should be apparent from Table 1, embodiments including a boost compressor 142 can result in an increase in expander 106 power (i.e., “Gas Turbine Expander Power”) due to the increase in pressure ratios. Although the power demand for the main compressor 104 can increase, its increase is more than offset by the increase in power output of the expander 106, thereby resulting in an overall thermodynamic performance efficiency improvement of around 1% lhv (lower heated value).

Moreover, the addition of the boost compressor 142 can also increase the power output of the nitrogen expander 152, when such an expander is incorporated. Still further, boost compressor 142 may increase the CO₂ pressure in the purge stream 146 line. An increase in purge pressure of the purge stream 146 can lead to improved solvent treating performance in the CO₂ separator 148 due to the higher CO₂ partial pressure. Such improvements can include, but are not limited to, a reduction in overall capital expenditures in the form of reduced equipment size for the solvent extraction process.

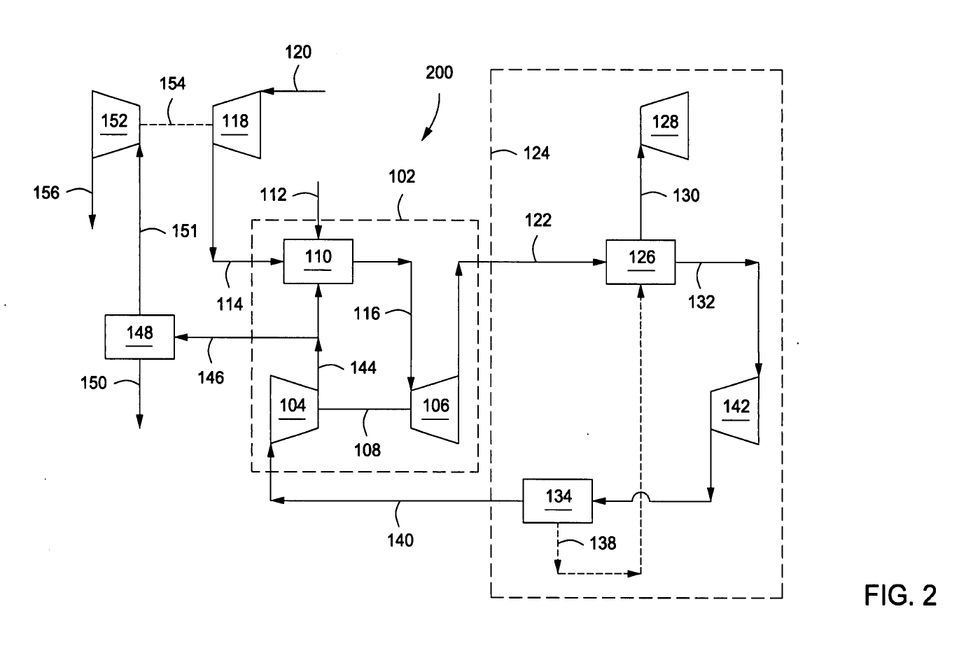

Referring now to FIG. 2, depicted is an alternative embodiment of the power generation system 100 of FIG. 1, embodied and described as system 200. As such, FIG. 2 may be best understood with reference to FIG. 1. Similar to the system 100 of FIG. 1, the system 200 of FIG. 2 includes a gas turbine system 102 coupled to or otherwise supported by an exhaust gas recirculation (EGR) system 124. The EGR system 124 in FIG. 2, however, can include an embodiment where the boost compressor 142 follows or may otherwise be fluidly coupled to the HRSG 126. As such, the cooled exhaust gas in line 132 can be compressed in the boost compressor 142 before being reduced in temperature in the cooling unit 134. Thus, the cooling unit 134 can serve as an aftercooler adapted to remove the heat of compression generated by the boost compressor 142. As with previously disclosed embodiments, the water dropout stream 138 may or may not be routed to the HRSG 126 to generate additional steam in line 130.

The cooled recycle gas stream 140 can then be directed to the main compressor 104 where it is further compressed, as discussed above, thereby generating the compressed recycle stream 144. As can be appreciated, cooling the cooled exhaust gas in line 132 in the cooling unit 134 after compression in the boost compressor 142 can reduce the amount of power required to compress the cooled recycle gas stream 140 to a predetermined pressure in the succeeding main compressor 104.

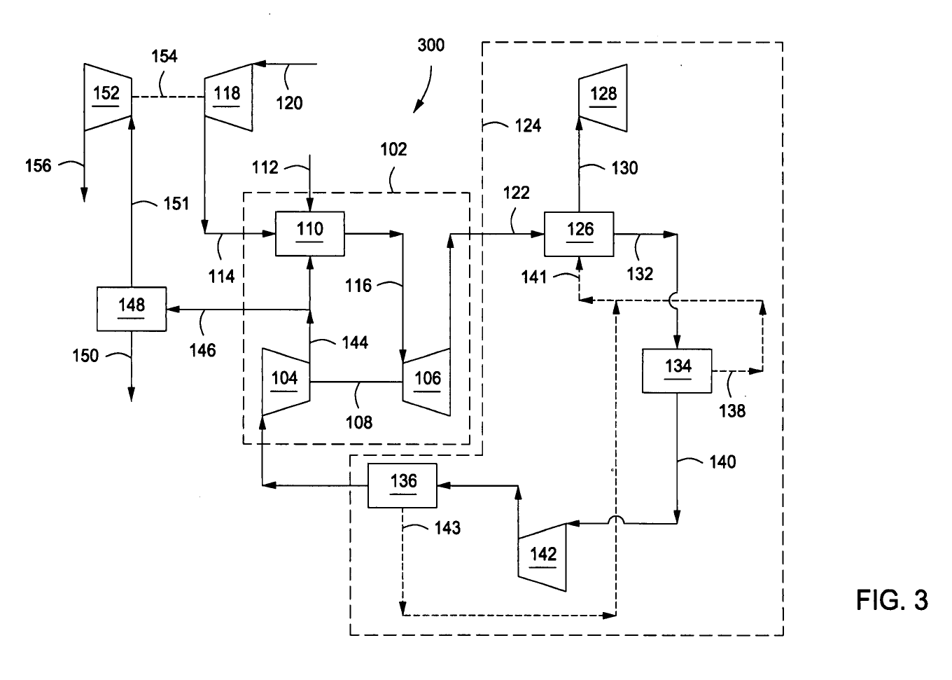

FIG. 3 depicts another embodiment of the low emission power generation system 100 of FIG. 1, embodied as system 300. As such, FIG. 3 may be best understood with reference to FIGS. 1 and 2. Similar to the systems 100, 200 described in FIGS. 1 and 2, respectively, the system 300 includes a gas turbine system 102 supported by or otherwise coupled to an EGR system 124. The EGR system 124 in FIG. 3, however, can include a first cooling unit 134 and a second cooling unit 136, having the boost compressor 142 fluidly coupled therebetween. As with previous embodiments, each cooling unit 134, 136 can be a direct contact cooler, trim cooler, or the like, as known in the art.

In one or more embodiments, the cooled exhaust gas in line 132 discharged from the HRSG 126 can be sent to the first cooling unit 134 to produce a condensed water dropout stream 138 and a cooled recycle gas stream 140. The cooled recycle gas stream 140 can be directed to the boost compressor 142 in order to boost the pressure of the cooled recycle gas stream 140, and then direct it to the second cooling unit 136. The second cooling unit 136 can serve as an aftercooler adapted to remove the heat of compression generated by the boost compressor 142, and also remove additional condensed water via a water dropout stream 143. In one or more embodiments, each water dropout stream 138, 143 may or may not be routed to the HRSG 126 to generate additional steam in line 130.

The cooled recycle gas stream 140 can then be introduced into the main compressor 104 to generate the compressed recycle stream 144 nominally above or at the combustion chamber 110 pressure. As can be appreciated, cooling the cooled exhaust gas in line 132 in the first cooling unit 134 can reduce the amount of power required to compress the cooled recycle gas stream 140 in the boost compressor 142. Moreover, further cooling exhaust in the second cooling unit 136 can reduce the amount of power required to compress the cooled recycle gas stream 140 to a predetermined pressure in the succeeding main compressor 104.

While the present disclosure may be susceptible to various modifications and alternative forms, the exemplary embodiments discussed above have been shown only by way of example. However, it should again be understood that the disclosure is not intended to be limited to the particular embodiments disclosed herein. Indeed, the present disclosure includes all alternatives, modifications, and equivalents falling within the true spirit and scope of the appended claims.

What is claimed is:

1. An integrated system, comprising:
a gas turbine system, comprising:
a first compressor configured to receive and compress a cooled recycle gas stream into a compressed recycle stream;
a second compressor configured to receive and compress a feed oxidant into a compressed oxidant;
a combustion chamber configured to receive the compressed recycle stream and the compressed oxidant and stoichiometrically combust a fuel stream, wherein the compressed recycle stream serves as a diluent to moderate combustion temperatures; and
an expander coupled to the first compressor and configured to receive a discharge from the combustion chamber to generate a gaseous exhaust stream and at least partially drive the first compressor; and
an exhaust gas recirculation system, comprising:
a heat recovery steam generator configured to receive the gaseous exhaust stream from the expander and generate steam and a cooled exhaust stream; and
a boost compressor configured to receive and increase the pressure of the cooled exhaust stream to provide a cooled recycle gas stream for injection into the first compressor.

2. The system of claim 1, wherein the exhaust gas recirculation system further comprises a steam gas turbine configured to receive the steam and generate electrical power.

3. The system of claim 1, wherein the feed oxidant is air, oxygen-rich air, and any combination thereof.

4. The system of claim 1, wherein the fuel stream is selected from the group consisting of: natural gas, methane, naphtha, butane, propane, syngas, diesel, kerosene, aviation fuel, coal derived fuel, bio-fuel, oxygenated hydrocarbon feedstock, and any combination thereof.

5. The system of claim 1, wherein the exhaust gas recirculation system further comprises a at least one cooling unit configured to receive at least one of the cooled exhaust stream and cooled recycle gas stream and to generate a water dropout stream and the cooled recycle gas stream.

6. The method of claim 5, wherein the water dropout stream is fluidly coupled to the heat recovery steam generator to generate additional steam.

7. The system of claim 1, wherein the gaseous exhaust stream is provided to the heat recovery unit at a pressure above atmospheric.

8. The system of claim 1, wherein the temperature of the gaseous exhaust stream exiting the expander is about 1250° F.

9. The system of claim 1, wherein the boost compressor increases the pressure of the cooled recycle gas stream to a pressure between about 17.1 psia to about 21 psia.

10. The system of claim 1, further comprising a purge stream taken from the compressed recycle stream.

11. The system of claim 10, wherein the purge stream is treated in a CO₂ separator to generate a carbon dioxide stream and a residual stream substantially comprising nitrogen gas.

12. The system of claim 10, wherein at least a portion of the purge stream is sent to a location for carbon dioxide sequestration, carbon dioxide sales, carbon capture, venting, or combinations thereof.

13. A method of generating power, comprising:
compressing a cooled recycle gas stream in a first compressor to generate a compressed recycle stream;
compressing a feed oxidant in a second compressor to generate a compressed oxidant;
combusting a fuel stream and the compressed oxidant in the presence of the compressed recycle stream in a combustion chamber, thereby generating a discharge, wherein the compressed recycle stream is adapted to moderate the temperature of the discharge;
expanding the discharge in an expander to generate a gaseous exhaust stream and at least one unit of power;
recovering heat from the gaseous exhaust discharge in a heat recovery steam generator to produce steam and a cooled exhaust stream; and
increasing the pressure of the cooled exhaust stream in a boost compressor to provide a cooled recycle gas stream for injection into the first compressor.

14. The method of claim 13, further comprising generating electrical power from the steam in a steam gas turbine.

15. The method of claim 13, further comprising cooling at least one of the cooled exhaust stream and the cooled recycle gas stream in a cooling unit to remove at least a portion of condensed water therefrom.

16. The method of claim 15, further comprising routing the portion of condensed water from the cooling unit to the heat recovery steam generator to generate additional steam.

17. The method of claim 13, further comprising:
removing a portion of the compressed recycle stream in a purge stream;
treating the purge stream in a CO₂ separator; and
discharging a carbon dioxide stream and a residual stream substantially comprising nitrogen gas from the CO₂ separator.

18. An integrated system, comprising:
a gas turbine system, comprising:
a first compressor configured to receive and compress a cooled recycle gas stream into a compressed recycle stream;
a second compressor configured to receive and compress a feed oxidant into a compressed oxidant;
a combustion chamber configured to receive the compressed recycle stream and the compressed oxidant and stoichiometrically combust a fuel stream; and
an expander coupled to the first compressor and configured to receive a discharge from the combustion chamber to generate a gaseous exhaust stream at a temperature of at least about 1250° F. and to generate at least one unit of power; and
an exhaust gas recirculation system, comprising:
a heat recovery steam generator configured to receive the gaseous exhaust stream from the expander and to generate steam and a cooled exhaust stream;
a boost compressor configured to receive and increase the pressure of the cooled exhaust stream to a pressure between about 17.1 psia to about 21 psia; and
a first cooling unit configured to receive the cooled exhaust stream from the boost compressor and generate a water dropout stream and the cooled recycle gas stream for, injection into the first compressor.

19. The system of claim 18, further comprising a purge stream taken from the compressed recycle stream and treated in a CO₂ separator to generate a carbon dioxide stream and a residual stream substantially comprising nitrogen gas.
